(19) United States
(12) Patent Application Publication
(10) Pub. No.: US 2019/0260122 A1
(43) Pub. Date: Aug. 22, 2019

(54) UNMANNED AERIAL VEHICLE AND ANTENNA ASSEMBLY

(71) Applicant: SZ DJI TECHNOLOGY CO., LTD., Shenzhen (CN)

(72) Inventors: Dong LI, Shenzhen (CN); Chao LV, Shenzhen (CN); Meng HU, Shenzhen (CN)

(21) Appl. No.: 16/400,515

(22) Filed: May 1, 2019

Related U.S. Application Data
(63) Continuation of application No. PCT/CN2016/104509, filed on Nov. 4, 2016.

(51) Int. Cl. H01Q 3/24; H01Q 1/28; B64D 47/08; B64C 39/02

(52) U.S. Cl. CPC H01Q 3/24; H01Q 1/285; B64C 2201/123; B64C 39/024; B64C 2201/127; B64D 47/08

(57) ABSTRACT

An unmanned aerial vehicle (UAV) includes an antenna assembly configured to communicate with a ground terminal controller, a memory storing antenna assembly configuration information, and one or more processors configured to adjust a radiation direction pattern of the antenna assembly according to the antenna assembly configuration information.

### CROSS-REFERENCE TO RELATED APPLICATION

This application is a continuation of International Application No. PCT/CN2016/104509, filed on Nov. 4, 2016, the entire contents of which are incorporated herein by reference.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to an antenna assembly and, more particularly, to a radiation-direction-pattern adaptive antenna assembly.

### BACKGROUND

An antenna carried by an unmanned aerial vehicle (UAV) is usually a directional antenna, and a radiation direction pattern of the antenna cannot adjust adaptively. The UAV constantly changes positions during flight. Thus, a maximum radiation direction of the radiation direction pattern cannot always face towards a ground control terminal, and communication and data transmission between the UAV and the ground control terminal are disturbed, such as image transmission, distance control, or the like.

### SUMMARY

In accordance with the disclosure, there is provided an unmanned aerial vehicle (UAV) including an antenna assembly configured to communicate with a ground terminal controller, a memory storing antenna assembly configuration information, and one or more processors configured to adjust a radiation direction pattern of the antenna assembly according to the antenna assembly configuration information.

Also in accordance with the disclosure, there is provided a method of controlling an unmanned aerial vehicle (UAV) including an antenna assembly. The method includes calculating a position of the UAV relative to a ground terminal controller, and adjusting a radiation direction pattern of the antenna assembly according to the position and antenna assembly configuration information.

Also in accordance with the disclosure, there is provided a method of controlling an unmanned aerial vehicle (UAV) including an antenna assembly. The method includes detecting signal strengths of the antenna assembly, and adjusting a radiation direction pattern of the antenna assembly according to the signal strengths and antenna assembly configuration information.

### BRIEF DESCRIPTION OF THE DRAWINGS

FIG. 1 is a schematic view of an example unmanned aerial vehicle (UAV) consistent with various disclosed embodiments of the present disclosure.

FIG. 2 is a schematic view of a bottom of an example UAV consistent with various disclosed embodiments of the present disclosure.

FIG. 3 is a block diagram of an example UAV consistent with various disclosed embodiments of the present disclosure.

FIG. 4 is a schematic view of an example antenna assembly for UAV consistent with various disclosed embodiments of the present disclosure.

FIGS. 5A-5E show example desired radiation direction patterns of UAV antenna assembly consistent with various disclosed embodiments of the present disclosure.

FIG. 6 is a schematic view of an example relative position between a UAV and a ground terminal controller consistent with various disclosed embodiments of the present disclosure.

FIG. 7 is a flowchart shows that an example UAV adaptively adjusts a radiation direction pattern of antenna assembly consistent with various disclosed embodiments of the present disclosure.

FIG. 8 is another flowchart shows that an example UAV adaptively adjusts a radiation direction pattern of antenna assembly consistent with various disclosed embodiments of the present disclosure.

FIG. 9 shows radiation direction patterns of an example UAV antenna assembly in different switch statuses consistent with various disclosed embodiments of the present disclosure.

FIG. 10 shows radiation direction patterns of an example UAV antenna assembly in different switch statuses consistent with various disclosed embodiments of the present disclosure.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

Example embodiments will be described with reference to the accompanying drawings, in which the same numbers refer to the same or similar elements unless otherwise specified.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them. The terms “perpendicular,” “horizontal,” “left,” “right,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

In the specification, claims, and accompanying drawings of the present disclosure, the terms “first,” “second,” and the like (if exist) are intended to distinguish between similar objects but do not necessarily indicate an order or sequence. It should be understood that the terms in such a way are interchangeable in proper circumstances, and the terms are used merely to distinguish between similar objects in descriptions of embodiments of the present disclosure. Moreover, the terms “include,” “contain” and any other similar expressions mean to cover the non-exclusive inclusion, for example, a process, method, system, product, or device that includes a list of steps or units, and are not necessarily limited to those steps or units that are explicitly listed, but may include other steps or units not explicitly listed or inherent to such a process, method, system, product, or device.

Further, in the present disclosure, the disclosed embodiments and the features of the disclosed embodiments may be combined when there are no conflicts.

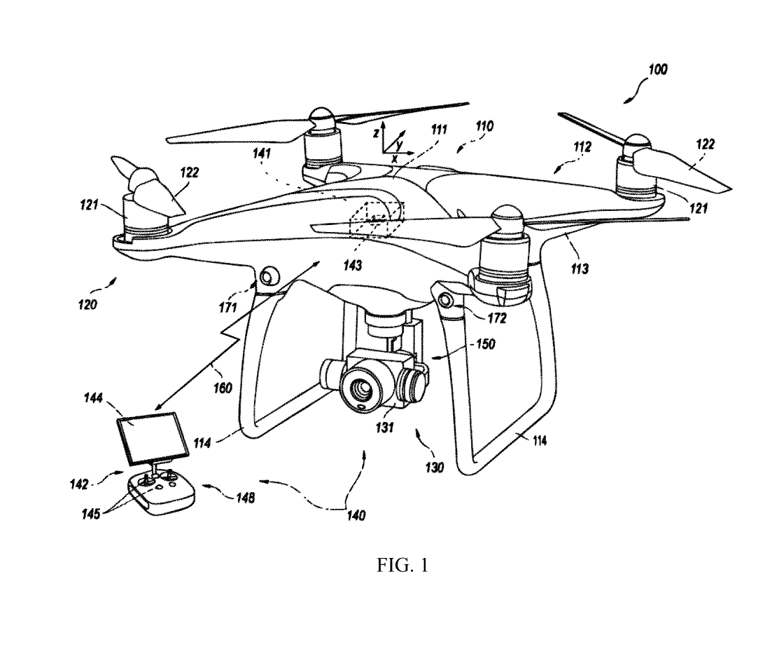

FIG. 1 is a schematic view of an example unmanned aerial vehicle (UAV) 100 consistent with various disclosed embodiments of the present disclosure. Referring to FIG. 1, the UAV 100 includes a fuselage 110. The fuselage 110 includes a central portion 111 and one or more outer portions 112. As shown in FIG. 1, in some embodiments, the fuselage 110 includes four outer portions 112, such as an arm 113. The four outer portions 112 extend from the central portion 111. In some other embodiments, the fuselage 110 may include any number of external portions 112, e.g., 6, 8, etc. In above-described examples, each of the outer portions 112 can carry a propelling system 120 that can drive the UAV 100 to move, e.g., climb, land, horizontally move, etc. For example, the arm 113 can carry a corresponding motor 121, and the motor 121 can drive a corresponding propeller 122 to rotate. The UAV 100 can control any set of motors 121 and corresponding propellers 122, without being affected by other motors 121 and corresponding propellers of the other motors 121.

The fuselage 110 can carry a load 130, such as an imaging apparatus 131. In some embodiments, the imaging apparatus 131 can include a camera. For example, the camera can take an image, a video, or the like, around the UAV. The camera may be photosensitive to light of various wavelengths including, but not limited to, visible light, ultraviolet light, infrared light, or any combination thereof. In some embodiments, the load 130 may include other types of sensors. In some embodiments, the load 130 may be coupled to the fuselage 110 through a gimbal 150, such that the load 130 can move relative to the fuselage 110. For example, when the load 130 carries or includes the imaging apparatus 131, the imaging apparatus 131 can move relative to the fuselage 110 to capture images, videos, and/or the like around the UAV 100. As shown in FIG. 1, a landing gear 114 can support the UAV 100 to protect the load 130, when the UAV 100 is on the ground.

In some embodiments, the UAV 100 includes a control system 140. The control system 140 includes components arranged in the UAV 100 and components that are separate from the UAV 100. For example, as shown in FIG. 1, the control system 140 includes a first controller 141 arranged at the UAV 100 and a second controller 142 that is remote from the UAV 100 and can communicate with the first controller 141, via a communication link 160, e.g., a wireless link. The first controller 141 can include one or more processors, memory, and an onboard computer readable medium 143a that can store program instructions for controlling behavior of the UAV 100. The behavior may include, but is not limited to, operations of the propelling system 120 and the imaging apparatus 131, controlling the UAV to perform automatic landing, and/or the like. The second controller 142 can include one or more processors, memory, an off-board computer readable medium 143b, and one or more input and output apparatuses 148, such as a display apparatus 144 and a control apparatus 145. An operator of the UAV 100 can remotely control the UAV 100 through the control apparatus 145 and receive feedback information from the UAV 100 through the display apparatus 144 and/or other apparatuses. In some other embodiments, the UAV 100 can operate autonomously, and correspondingly the second controller 142 can be omitted, or the second controller 142 can be used by the operator to rewrite a function for a UAV flight. For example, the UAV 100 may be controlled by an onboard software development kit. The onboard computer readable medium 143a can be moved out of the UAV 100. The offboard computer readable medium 143b can be moved out of the second controller 142.

In some embodiments, the UAV 100 includes two forward looking cameras 171 and 172 that are sensitive to light of various wavelengths, e.g., visible light, infrared light, ultraviolet light, and are used for taking images or videos around the UAV. In some embodiments, the UAV 100 includes one or more sensors arranged at a bottom of the UAV.

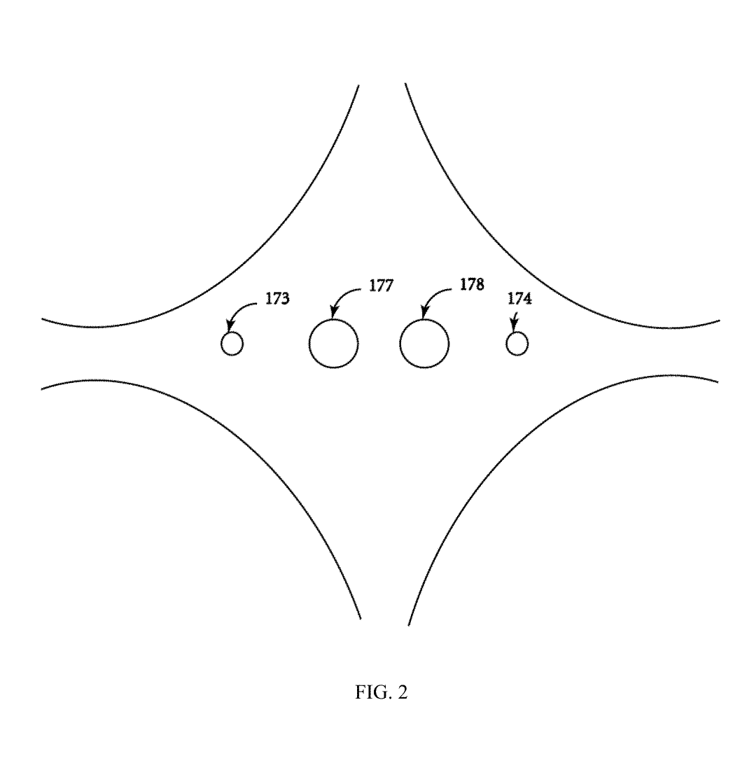

FIG. 2 is a schematic view of a bottom of an example UAV consistent with various disclosed embodiments of the present disclosure. The UAV 100 includes two down looking cameras 173 and 174 arranged at a bottom of the fuselage 110. In addition, the UAV 100 further includes two ultrasonic sensors 177 and 178 arranged at the bottom of the fuselage 110. The ultrasonic sensors 177 and 178 can detect and/or monitor objects and ground under the bottom of the UAV 100 and measure a distance from the object or the ground by transmitting and receiving ultrasonic waves.

In some other embodiments, the UAV 100 may include an inertial measurement unit (IMU), an infrared sensor, a microwave sensor, a temperature sensor, a proximity sensor, a three-dimensional (3D) laser range finder, a 3D time-of-flight (TOF) apparatus, etc. The 3D laser range finder and the 3D TOF apparatus can detect the distance between the UAV and an object or a ground beneath the UAV.

In some embodiments, the IMU can be used for measuring height and attitude information of UAV. The attitude information includes, but is not limited to, pitch angle, roll angle, and yaw angle. The IMU may include, but is not limited to, one or more accelerometers, gyroscopes, magnetometers, or any combination thereof. The accelerometer can be used for measuring an acceleration of the UAV to calculate a speed of the UAV.

In some embodiments, the UAV further includes a barometer that can be used for detecting a height of the UAV.

In some embodiments, the UAV may further include a global position system (GPS) unit (not shown). The GPS unit may be configured to obtain location information of the UAV, such as coordinates, latitude and longitude, and/or the like. The GPS unit may be further configured to obtain a horizontal distance between the UAV and a ground terminal controller. The ground terminal controller may include, but is not limited to, a remote controller, a ground terminal image transmission apparatus, and/or the like.

In some embodiments, the UAV may further include a power system. The power system may include at least one electric motor and at least one electronic speed controller (ESC). The power system may be used for providing flight power to the UAV.

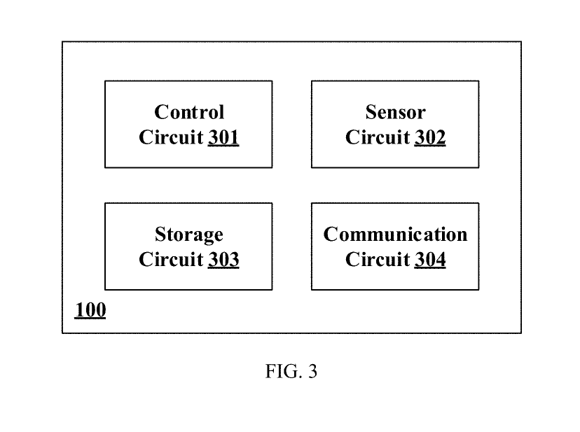

FIG. 3 is a block diagram of an example UAV consistent with various disclosed embodiments of the present disclosure. Referring to FIG. 3, the UAV 100 includes a control circuit 301, a sensor circuit 302, a storage circuit 303, and a communication circuit 304.

The control circuit 301 may include one or more processors. The processor can include, but not limited to a microprocessor, a reduced instruction set computer (RISC), an application specific integrated circuit (ASIC), an application-specific instruction-set processor (ASIP), a central processing unit (CPU), a physics processing unit (PPU), a digital signal processor (DSP), a field programmable gate array (FPGA), etc.

The sensor circuit 302 may include one or more sensors. The sensor may include, but is not limited to, a temperature sensor, a time of flight (TOF) sensor, an inertial measurement unit, an accelerometer, an image sensor such as a camera, an ultrasonic sensor, a microwave sensor, a proximity sensor, a 3D laser range finder, an infrared sensor, a barometer, etc.

In some embodiments, the inertial measurement unit can be used to measure a height of the UAV. The inertial measurement unit may include, but is not limited to, one or more accelerometers, gyroscopes, magnetometers, or any combination thereof. The accelerometer can be used for measuring an acceleration of the UAV to calculate a speed of the UAV.

The storage circuit 303 can include, but is not limited to, a read only memory (ROM), a random access memory (RAM), a programmable read only memory (PROM), an electronic erasable programmable read only memory (EEPROM), and/or the like. The storage circuit 303 can include a non-transitory computer readable medium that can store codes, logics or instructions for performing one or more processes described elsewhere herein. The control circuit 301 can perform one or more processes separately or collectively according to codes, logics or instructions of the non-transitory computer readable medium described herein.

In some embodiments, the storage circuit 303 may be configured to store preset antenna assembly configuration information. The one or more processors may adjust a radiation direction pattern of the UAV according to the preset antenna assembly configuration information.

The communication circuit 304 can include, but is not limited to, an antenna assembly or the like. The antenna assembly may be used for communicating with a ground terminal controller. In some embodiments, the one or more processors can adjust a radiation direction pattern of the antenna assembly according to the preset antenna assembly configuration information.

In some embodiments, the UAV may further include an input and output circuit (not shown). The input and output circuit may be used for outputting information or instructions to an external device. For example, the input and output circuit may receive instructions sent from the input and output apparatus 148 (see FIG. 1), or transmit an image taken by the imaging apparatus 131 (see FIG. 1) to the input and output apparatus 148.

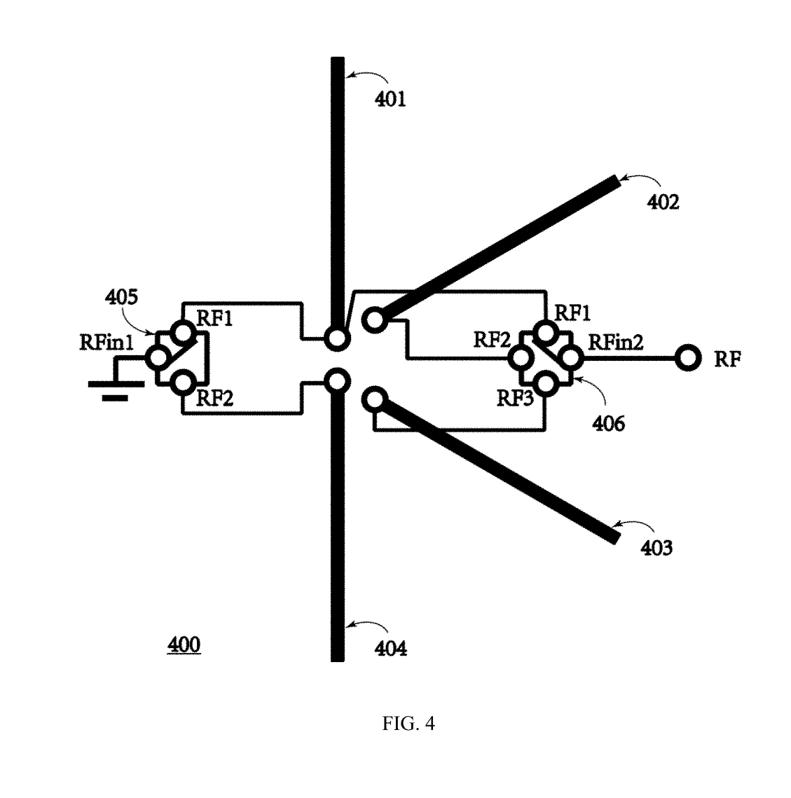

FIG. 4 is a schematic view of an example antenna assembly for UAV consistent with various disclosed embodiments of the present disclosure. As shown in FIG. 4, the antenna assembly 400 includes four antennas, i.e., an antenna 401, an antenna 402, an antenna 403, and an antenna 404, and two switches, i.e., a switch 405 and a switch 406.

In some embodiments, the antenna assembly may be arranged within a landing gear of the UAV, or arranged in the fuselage.

In some embodiments, the antenna 401, the antenna 402, the antenna 403, and the antenna 404 may be arranged at an angle difference of approximately 60 degrees. The switch 405 may include a single pole double throw switch, and the switch 406 may include a single pole triple throw switch. A common terminal RFin1 of the switch 405 may be grounded, and a common terminal RFin2 of the switch 406 may be coupled to an input signal. The input signal may include, but is not limited to, a control signal sent by the ground terminal controller to the antenna assembly 400, a signal indicating status information sent by the antenna assembly 400 to the ground terminal controller, and/or an image signal sent by the antenna assembly 400 to the ground terminal controller.

In some embodiments, at least one of the antenna 401, the antenna 402, the antenna 403, or the antenna 404 may include, but is not limited to, a dipole antenna, a monopole antenna, an inverted-F antenna, a loop antenna, etc.

In some embodiments, the UAV may connect at least two of the four antennas by configuring the switch 405 and/or the switch 406 according to the preset antenna assembly configuration information. Accordingly, a radiation direction pattern of the antenna assembly 400 may be changed. The preset antenna assembly configuration information may include Table 1 and Table 2. Referring to Table 1, Table 1 shows a switch configuration truth table and corresponding switch statuses. Switch 405 includes two terminals RF1 and RF2, and Ctrl indicates a signal that controls a status of switch 405. Similarly, switch 406 includes three terminals RF1, RF2, and RF3, and Ctrl2 indicates a signal that controls a status of switch 406. In some embodiments, one or more processors of the UAV may send Ctrl or Ctrl2 to control statuses of the switch 405 and the switch 406.

In some embodiments, Table 1 can be stored in the memory of the UAV.

In some embodiments, the UAV may control statuses of the switch 405 and the switch 406 to obtain a desired radiation direction pattern, according to a position relative to the ground terminal controller, e.g., a remote controller, a ground terminal image transmission apparatus, etc. The position may include, for example, a tilt angle or the like.

Referring to Table 2, a indicates a tilt angle of the UAV with respect to the ground terminal controller. Different tilt angles correspond to different radiation direction patterns and switch statuses. For example, a tilt angle α that is greater than approximately 57 degrees and less than approximately 90 degrees may correspond to radiation direction pattern 1 and switch status 1.

In some embodiments, Table 2 can be stored in the memory of the UAV.

The above-described switch structures are merely for illustrative purposes and are not to be considered as the only implementations of the present disclosure. It will be apparent to those skilled in the art that the structure of the above-described switch components can be modified or changed based on the understanding of the present disclosure, but the modifications or variations are still within the scope of the present disclosure. For example, the antenna assembly may include three or more switches, five or more antennas, and the angles between the five or more antennas may be the same or different.

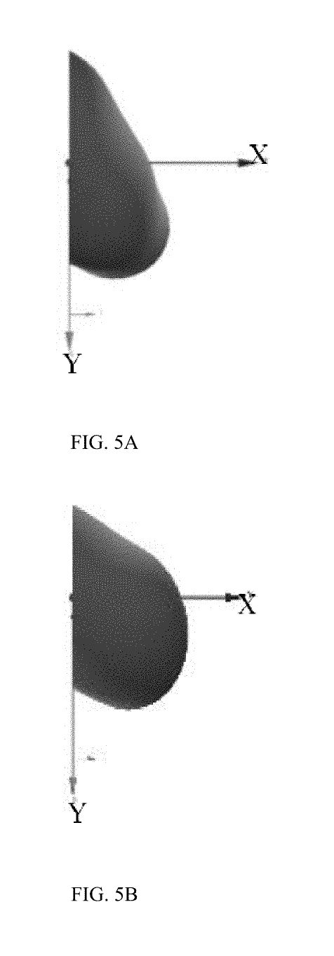

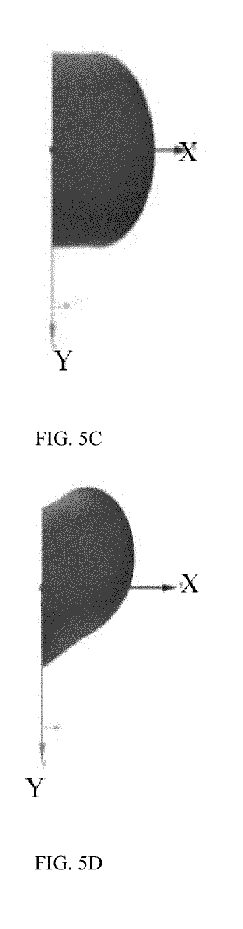

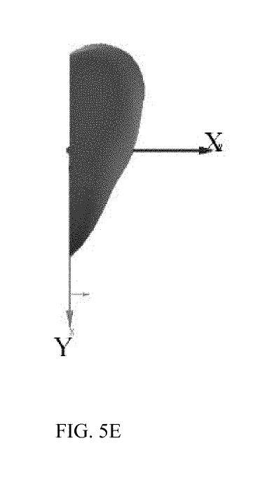

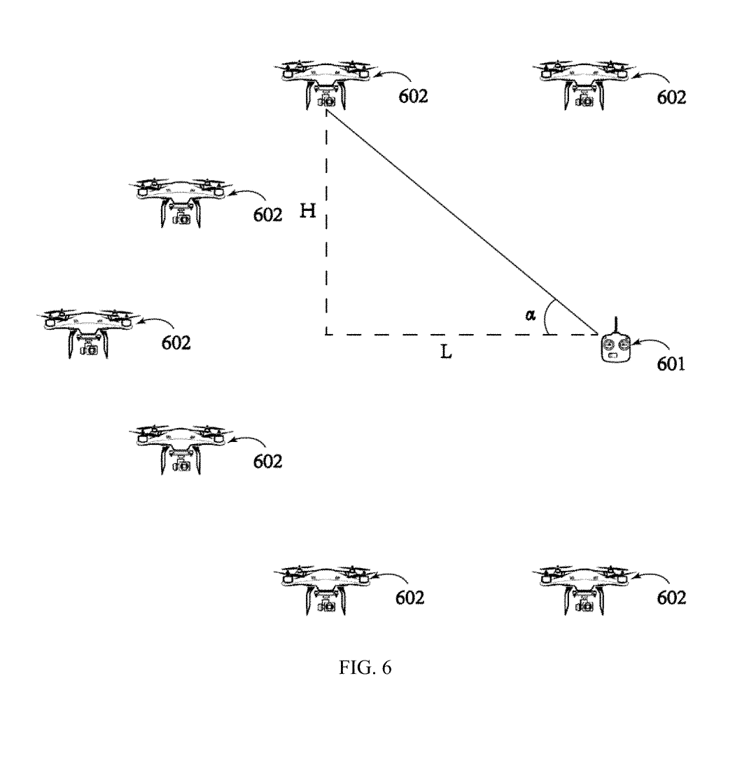

Reference is now made to FIGS. 5A-5E and 6. FIGS. 5A-5E show example desired radiation direction patterns of UAV antenna assembly consistent with various disclosed embodiments of the present disclosure. FIG. 6 is a schematic view of an example relative position between a UAV and a ground terminal controller consistent with various disclosed embodiments of the present disclosure. As shown in FIG. 6, the UAV can move relative to the ground terminal controller 601, and α indicates a tilt angle of the UAV 602 relative to the ground terminal controller 601. H indicates a vertical distance of the UAV 602 with respect to the ground terminal controller 601. L indicates a horizontal distance of the UAV 602 with respect to the ground terminal controller 601. In the present disclosure, by determining a position of the UAV 602 relative to the ground terminal controller 601, and controlling the switch 405 and the switch 406, a desired radiation direction pattern may be obtained, such that the radiation direction of the antenna assembly may be maintained to face towards the ground terminal controller 601. Accordingly, image transmission quality and distance control of the UAV may be improved. Reference is made to FIGS. 5A-5E and Table 2 in the description below. FIG. 5A shows a corresponding desired radiation direction pattern when the tilt angle α is greater than approximately 57 degrees and less than or equal to approximately 90 degrees. FIG. 5B shows a corresponding desired radiation direction pattern when the tilt angle α is greater than approximately 32 degrees and less than or equal to approximately 57 degrees. FIG. 5C shows a corresponding desired radiation direction pattern when the tilt angle α is greater than approximately −32 degrees and less than or equal to approximately 32 degrees. FIG. 5D shows a corresponding desired radiation direction pattern when the tilt angle α is greater than −57 degrees and less than or equal to approximately −32 degrees. FIG. 5E shows a corresponding desired radiation direction pattern when the tilt angle α is greater than or equal to −90 degrees and less than or equal to greater −57 degrees.

In some embodiments, the UAV may detect a vertical distance H by one or more onboard sensors, e.g., ultrasonic sensors, TOF sensors, barometers, etc., and detect a horizontal distance by a GPS unit, to calculate the tilt angle α. The UAV can control the switch 405 and the switch 406 to obtain a desired radiation direction pattern according to the tilt angle α. For example, the one or more processors of the UAV may send control signals, such as Ctrl, Ctrl2, etc., to the switch 405 and the switch 406 to control statuses of the switch 405 and the switch 406 to obtain the desired radiation direction pattern.

For example, the UAV may calculate that the tilt angle α is approximately 40 degrees. The one or more processors of the UAV may determine a desired radiation direction pattern and a corresponding switch status, by querying Table 2 according to the tilt angle α. The one or more processors may query Table 1 according to the obtained switch status to obtain corresponding switch configuration information. The one or more processors may send control signals to the switch 405 and/or the switch 406 according to the obtained switch configuration information, to control the antenna assembly to generate the desired radiation direction pattern. For example, the tilt angle α may be approximately 40 degrees, and the one or more processors may determine a desired radiation direction pattern as FIG. 5B by querying Table 2, and a corresponding switch status as status 2. The one or more processors may query Table 1 according to status 2 to obtain switch configuration information. The configuration information may include information indicating that the switch 405 is connected to terminal RF1, and the switch 406 is connected to terminal RF3. Further, the one or more processors may send a control signal Ctrl having a value of 0 to the switch 405 to cause the switch 405 to be connected to terminal RF1. Similarly, the one or more processors can send a control signal Ctrl2 having a value of 10 to the switch 406 to cause the switch 406 to be connected to terminal RF3. After the switch configuration is completed, the antenna assembly can obtain, e.g., generate, a desired radiation direction pattern, e.g., FIG. 5B, to align the radiation direction of the antenna assembly towards the ground terminal controller.

In some embodiments, the UAV can detect the tilt angle α in real time, and in response to the tilt angle α being changed, the UAV can determine a new desired radiation direction pattern and corresponding switch configuration information. The UAV can obtain the new desired radiation direction pattern by controlling the switch 405 and the switch 406, such that the radiation direction of the UAV antenna assembly may be maintained to face toward the ground terminal controller, thereby improving image transmission quality and distance control of the UAV.

In some other embodiments, the UAV may detect the tilt angle α from time to time. For example, the UAV can control a period for detecting the tilt angle α according to a flight speed. Such a period is also referred to as a “detection period.” If the flight speed of the UAV is relatively high, the detection period for the tilt angle α may be reduced. If the flight speed of the UAV is relatively low or equals zero, the detection period for the tilt angle α can be increased.

The desired radiation direction patterns in FIGS. 5A-5E are merely for illustrative purposes and are not intended to limit the scope of the present disclosure. In some embodiments, the structure of the switch component may be changed, and the UAV may include any number of desired radiation patterns, e.g., six or more desired radiation direction patterns.

TABLE 1
switch configuration truth table and corresponding switch statuses

| | Switch 405 Status | | | Switch 406 Status | | | |
|---|---|---|---|---|---|---|---|
| Switch Status | Ctrl | RF1 | RF2 | Ctrl2 | RF1 | RF2 | RF3 |
| Status 1 | 0 | 1 | 0 | 01 | 0 | 1 | 0 |
| Status 2 | 0 | 1 | 0 | 10 | 0 | 0 | 1 |
| Status 3 | 1 | 0 | 1 | 00 | 1 | 0 | 0 |
| Status 4 | 1 | 0 | 1 | 01 | 0 | 1 | 0 |
| Status 5 | 1 | 0 | 1 | 10 | 0 | 0 | 1 |

TABLE 2
tilt angle Vs. switch status

| Tilt Angle | Radiation Direction Pattern | Switch Status |
|---|---|---|
| 57 < α ≤ 90 | FIG. 5A | Status 1 |
| 32 < α ≤ 57 | FIG. 5B | Status 2 |
| −32 < α ≤ 32 | FIG. 5C | Status 3 |
| −57 < α ≤ −32 | FIG. 5D | Status 4 |
| −90 ≤ α ≤ −57 | FIG. 5E | Status 5 |

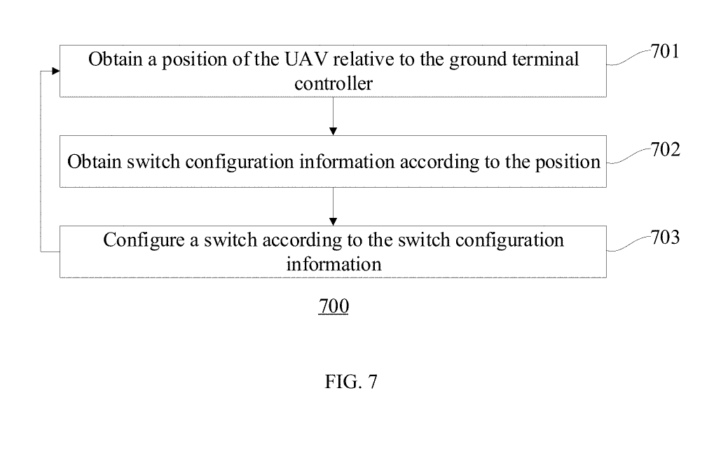

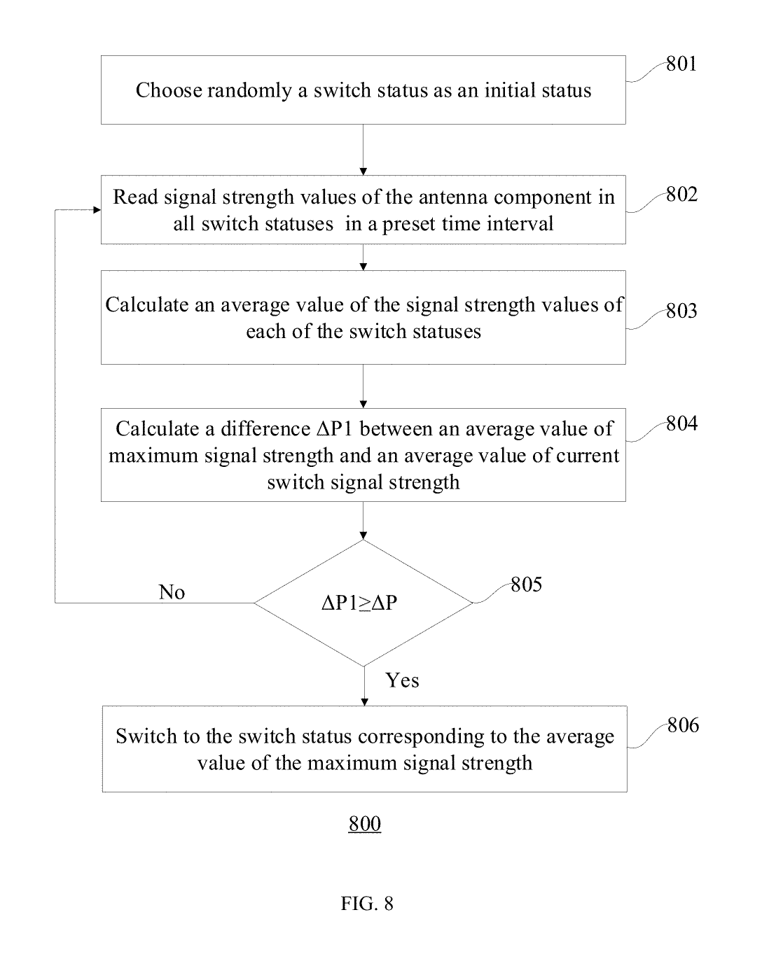

FIG. 7 is a flowchart shows that an example UAV adaptively adjust a radiation direction pattern of antenna assembly consistent with various disclosed embodiments of the present disclosure.

At 701, a position of the UAV relative to the ground terminal controller is obtained.

In some embodiments, the position of the UAV relative to the ground terminal controller may include the tilt angle α described in connection with FIG. 6. The processor of the UAV may detect a vertical distance H and a horizontal distance L of the UAV relative to the ground terminal controller, through an onboard sensor, e.g., an ultrasound sensor, a TOF sensor, a barometer, a GPS unit, etc., and calculate the tilt angle α according to Equation 1. The ground terminal controller may include, but is not limited to, a remote controller, a ground terminal image transmission apparatus, etc.

$$α = arctan ( \frac{H}{L} ) \qquad ( Equation 1 )$$

At 702, switch configuration information is obtained according to the position.

In some embodiments, the processor may query the preset antenna assembly configuration information, e.g., Tables 1 and 2, stored in the UAV according to a position, such as the tilt angle α, of the UAV relative to the ground control terminal, e.g., the ground terminal controller, to determine a desired radiation direction pattern and corresponding switch configuration information, such as configuration information of the switch 405 and the switch 406. The switch configuration information can be used for configuring conduction modes of the switch 405 and the switch 406.

At 703, a switch is configured according to the switch configuration information.

In some embodiments, the processor may send control signals, e.g., Ctrl, Ctrl2, etc., to the switch 405 and the switch 406 according to the switch configuration information in process 702 to obtain a desired radiation direction pattern.

The above-described flow charts are merely for illustrative purposes and are not intended to limit the scope of the present disclosure. It will be apparent to those skilled in the art that the processes in the above-described flowcharts may be added, deleted, and/or changed based on the understanding of the present disclosure, but modifications to the flowcharts are still within the scope of the present disclosure. For example, the UAV may periodically detect a vertical distance H and a horizontal distance L to calculate a tilt angle α.

FIG. 8 is another flowchart shows that an example UAV adaptively adjusts a radiation direction pattern of antenna assembly consistent with various disclosed embodiments of the present disclosure.

At 801, a switch status is randomly chosen as an initial status.

In some embodiments, the UAV can randomly select a switch status, such as status 2, as an initial state according to the switch configuration information in Table 1.

At 802, signal strength values of the antenna assembly in all switch statuses are read in a preset time interval.

In some embodiments, the one or more processors of the UAV can read the signal strength values of the antenna assembly in all switch statuses, such as a received signal strength indicator (RSSI) value, within a preset time interval Δt. In some embodiments, the signal strength value may include an instantaneous signal strength value, such as an instantaneous RSSI value. In some embodiments, the preset time interval Δt may be, for example, greater than or equal to approximately 100 ms, and less than or equal to approximately 1 s.

As shown in Table 3, the one or more processors of the UAV may choose three time points within a preset time interval, such as 2 seconds, and read instantaneous signal strength values three times for each of the switch statuses.

At 803, an average value of the signal strength values of each of the switch statuses is calculated.

In some embodiments, the one or more processors may calculate an average value of the signal strength values for each of the switch statuses according to the signal strength values read in process 802. For example, referring to Table 3, each switch status corresponds to an average value of signal strength value, and the signal strength value, e.g., an average value of signal strength value, corresponding to status 1 is approximately 1.567.

At 804, a difference ΔP1 between an average value of maximum signal strength and an average value of current switch signal strength is calculated.

Referring to Table 3, the current switch status is status 2, and the average value of the corresponding signal strength is approximately 0.7. The average value of maximum signal strength in all switch statuses is approximately 2.833. Thus, ΔP1 can be calculated to be approximately 2.133.

At 805, the difference ΔP1 between the average value of the maximum signal strength and the average value of the current switch signal strength is compared with a threshold switching value ΔP. If ΔP1 is less than ΔP, the current switch status is maintained, and the signal strength values of the antenna assembly in all switching statuses are continued to be read in a preset time interval.

At 806, the switch status corresponding to the average value of the maximum signal strength is switched to.

In some embodiments, if ΔP1 is greater than or equal to ΔP, the processor can control the switch 405 and the switch 406 to switch to switch statuses corresponding to an average value of maximum signal strength. For example, if ΔP is approximately 0.3 dB and ΔP1 is greater than approximately 0.3 dB, the processor may send control signals to the switch 405 and/or the switch 406 to switch the switch status to status 3.

TABLE 3
signal strength values and average thereof in
a preset time interval for all switch statuses

| | 0.4 | 0.8 | 1.2 | Average |
|---|---|---|---|---|
| Switch Status | seconds | seconds | seconds | Value |
| Status 1 | 1.2 | 1.6 | 1.9 | 1.567 |
| Status 2 | 0.7 | 0.6 | 0.8 | 0.7 |
| Status 3 | 2.5 | 3.1 | 2.9 | 2.833 |
| Status 4 | 0.2 | 0.5 | 0.9 | 0.533 |
| Status 5 | 1.7 | 1.6 | 1.9 | 1.733 |

The above-described flow charts are merely for illustrative purposes and are not intended to limit the scope of the present disclosure. It will be apparent to those skilled in the art that the processes in the above-described flowcharts may be added, deleted, and/or changed based on the understanding of the present disclosure, but modifications to the flowcharts are still within the scope of the present disclosure. For example, the threshold switching value ΔP can be adjusted in real time, and the preset time interval Δt can be adjusted in real time. As another example, when the UAV is flying relatively fast, a detection speed may be increased. That is, Δt may be reduced. When the UAV is flying relatively slow, the detection speed may be reduced. That is, Δt may be increased.

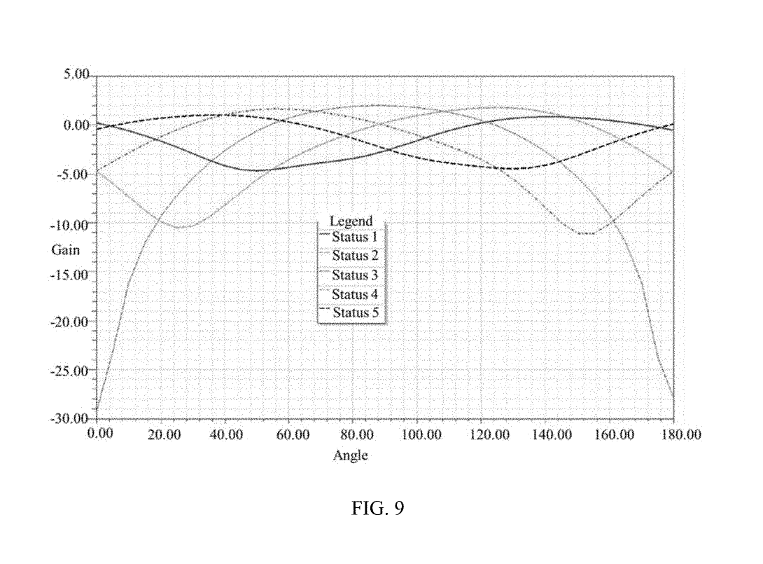

FIG. 9 shows radiation direction patterns of an example UAV antenna assembly in different switch statuses consistent with various disclosed embodiments of the present disclosure. As shown in FIG. 9, maximum gains of different switch statuses correspond to different angles. For example, a maximum gain of status 3 corresponds to an angle of approximately 90 degrees. The antenna assembly of the present disclosure can adjust the radiation direction pattern of the antenna assembly as the UAV is at different positions, such that the maximum radiation direction of the antenna assembly is maintained to face towards the ground terminal controller. That is, a maximized gain of communication between the antenna assembly and the ground terminal controller, e.g., a gain optimization of approximately 5 dB or more, can be realized in various directions. Accordingly, speed and quality of image transmission may be ensured, and distance control of the UAV may be improved.

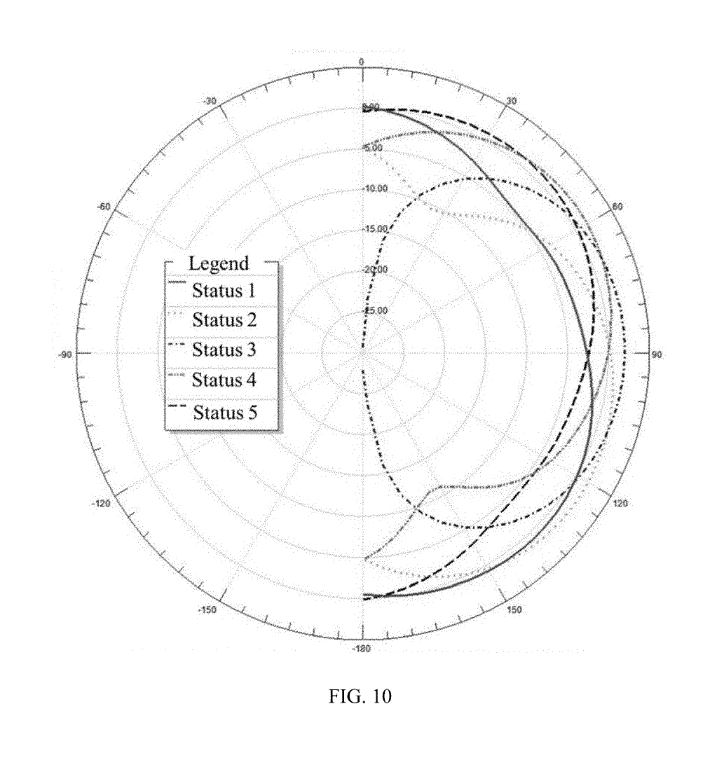

FIG. 10 shows radiation direction patterns of an example UAV antenna assembly in different switch statuses consistent with various disclosed embodiments of the present disclosure. As shown in FIG. 10, maximum gains of different switch statuses correspond to different angles. For example, a maximum gain of status 3 corresponds to an angle of approximately 90 degrees. The antenna assembly of the present disclosure can adjust the radiation direction pattern of the antenna assembly as the UAV is at different positions, such that the maximum radiation direction of the antenna assembly is maintained to face towards the ground terminal controller. That is, a maximized gain of communication between the antenna assembly and the ground terminal controller, e.g., a gain optimization of approximately 5 dB or more, can be realized in various directions. Accordingly, speed and quality of image transmission may be ensured, and distance control of the UAV may be improved.

The above-described examples are merely for illustrative purposes and are not intended to limit the scope of the present disclosure. Equivalent structures or equivalent process transformations based on specification and drawing contents of the present disclosure may be directly or indirectly applied to other related technologies, and fall with the scope of the present disclosure.

Those of ordinary skill in the art will appreciate that the example elements and algorithm steps described above can be implemented in electronic hardware, or in a combination of computer software and electronic hardware. Whether these functions are implemented in hardware or software depends on the specific application and design constraints of the technical solution. One of ordinary skill in the art can use different methods to implement the described functions for different application scenarios, but such implementations should not be considered as beyond the scope of the present disclosure.

For simplification purposes, detailed descriptions of the operations of example systems, devices, and units may be omitted and references can be made to the descriptions of the example methods.

The disclosed systems, apparatuses, and methods may be implemented in other manners not described here. For example, the devices described above are merely illustrative. For example, the division of units may only be a logical function division, and there may be other ways of dividing the units. For example, multiple units or components may be combined or may be integrated into another system, or some features may be ignored, or not executed. Further, the coupling or direct coupling or communication connection shown or discussed may include a direct connection or an indirect connection or communication connection through one or more interfaces, devices, or units, which may be electrical, mechanical, or in other form.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processing unit, or each unit may be an individual physically unit, or two or more units may be integrated in one unit. The above-described integrated units can be implemented in electronic hardware, or in a combination of computer software and electronic hardware.

A method consistent with the disclosure can be implemented in the form of computer program stored in a non-transitory computer-readable storage medium, which can be sold or used as a standalone product. The computer program can include instructions that enable a computing device, such as a processor, a personal computer, a server, or a network device, to perform part or all of a method consistent with the disclosure, such as one of the example methods described above. The storage medium can be any medium that can store program codes, for example, a USB disk, a mobile hard disk, a read-only memory (ROM), a random access memory (RAM), a magnetic disk, or an optical disk.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. An unmanned aerial vehicle (UAV) comprising:
an antenna assembly configured to communicate with a ground terminal controller;
a memory storing antenna assembly configuration information; and
one or more processors configured to adjust a radiation direction pattern of the antenna assembly according to the antenna assembly configuration information.

2. The UAV according to claim 1, wherein the antenna assembly includes a first switch, a second switch, a first antenna, a second antenna, a third antenna, and a fourth antenna.

3. The UAV according to claim 2, wherein the one or more processors are further configured to:
calculate a tilt angle of the UAV relative to the ground terminal controller; and
adjust the radiation direction pattern of the antenna assembly according to the tilt angle and the antenna assembly configuration information.

4. The UAV according to claim 3, wherein the one or more processors are further configured to:
obtain a vertical height of the UAV relative to the ground terminal controller;
obtain a horizontal distance of the UAV relative to the ground terminal controller; and
calculate the tilt angle according to the vertical height and the horizontal distance.

5. The UAV according to claim 4, wherein the one or more processors are further configured to:
determine a desired radiation direction pattern and corresponding switch configuration information from the antenna assembly configuration information according to the tilt angle; and
configure the antenna assembly to generate the desired radiation pattern according to the switch configuration information.

6. The UAV according to claim 3, wherein the one or more processors are further configured to calculate the tilt angle of the UAV repeatedly according to a time period, the time period being negatively correlated with a speed of the UAV.

7. The UAV according to claim 3, wherein the antenna assembly configuration information includes a plurality of tilt angle ranges, a plurality of radiation direction patterns each corresponding to one of the tilt angle ranges, and a plurality of switch statuses each corresponding to one of the radiation direction patterns.

8. The UAV according to claim 2, wherein the one or more processors are further configured to:
detect signal strengths of the antenna assembly;
adjust the radiation direction pattern of the antenna assembly according to the signal strengths and the antenna assembly configuration information.

9. The UAV according to claim 8, wherein:
the antenna assembly includes at least five switch statuses; and
the one or more processors are further configured to:
detect the signal strengths of the at least five switch statuses in a preset time interval;
extract a maximum signal strength from the signal strengths of the at least five switching statuses;
calculate a difference between the maximum signal strength and a current signal strength of a current switch status;
analyze the difference between the maximum signal strength and the current signal strength according to a threshold switching value; and
control the antenna assembly to switch to a switch status corresponding to the maximum signal strength in response to the difference being greater than or equal to the threshold switching value.

10. The UAV according to claim 9, wherein the preset time interval is negatively correlated to a speed of the UAV.

11. The UAV according to claim 8, wherein the antenna assembly configuration information includes switch configuration information of switches of the antenna assembly.

12. The UAV according to claim 2, wherein the first switch includes a single pole double throw switch, and the second switch includes a single pole triple throw switch.

13. The UAV according to claim 2, wherein the first antenna, the second antenna, the third antenna, and the fourth antenna are arranged at an angle difference of approximately 60 degrees.

14. The UAV according to claim 2, wherein at least one of the first antenna, the second antenna, the third antenna, or the fourth antenna includes at least one of a dipole antenna, a monopole antenna, an inverted-F antenna, or a loop antenna.

15. A method of controlling an unmanned aerial vehicle (UAV) including an antenna assembly, comprising:
calculating a position of the UAV relative to a ground terminal controller; and
adjusting a radiation direction pattern of the antenna assembly according to the position and antenna assembly configuration information.

16. The method according to claim 15, wherein the position includes a tilt angle of the UAV relative to the ground terminal controller.

17. The method according to claim 16, further comprising:
obtaining a vertical height of the UAV relative to the ground terminal controller;
obtaining a horizontal distance of the UAV relative to the ground terminal controller;
calculating the tilt angle according to the vertical height and the horizontal distance; and
adjusting the radiation direction pattern of the antenna assembly according to the tilt angle and the antenna assembly configuration information.

18. The method according to claim 17, wherein adjusting the radiation direction pattern of the antenna assembly includes:
determining a desired radiation direction pattern and corresponding switch configuration information from the antenna assembly configuration information according to the tilt angle; and
configuring the antenna assembly to generate the desired radiation pattern according to the switch configuration information.

19. A method of controlling an unmanned aerial vehicle (UAV) including an antenna assembly, comprising:
detecting signal strengths of the antenna assembly; and
adjusting a radiation direction pattern of the antenna assembly according to the signal strengths and antenna assembly configuration information.

20. The method according to claim 19,
wherein the antenna assembly includes at least five switch statuses;
the method further comprising:
detecting the signal strengths of the at least five switch statuses in a preset time interval;
extracting a maximum signal strength from the signal strengths of the at least five switching statuses;
calculating a difference between the maximum signal strength and a current signal strength of a current switch status;
analyzing the difference between the maximum signal strength and the current signal strength according to a threshold switching value; and
controlling the antenna assembly to switch to a switch status corresponding to the maximum signal strength in response to determining that the difference is greater than or equal to the threshold switching value.
